(19) United States
(12) Patent Application Publication
(10) Pub. No.: US 2008/0303250 A1
(43) Pub. Date: Dec. 11, 2008

(54) Anti-collision air bag for protecting articles in a trunk

(76) Inventor: Yi-Chia Liao, Miaoli County (TW)

Correspondence Address: Joe McKinney Muncy, PO Box 1364, Fairfax, VA, 22038-1364, US

(21) Appl. No.: 11/808,486

(22) Filed: Jun. 11, 2007

(51) Int. Cl. B60R 21/16

(52) U.S. Cl. 280/728.1

(57) ABSTRACT

The present invention discloses an anti-collision air bag for protecting articles inside a trunk, which comprises an air bag. The air bag has an inflation inlet, and the inflation inlet has a trumpet shape with the larger opening thereof arranged outside and has a check valve. The anti-collision air bag of the present invention is placed inside a trunk to cushion the articles inside the trunk and prevent the articles from damage.

### FIELD OF THE INVENTION

The present invention relates to an air bag, particularly to an anti-collision air bag for protecting articles inside a trunk.

### BACKGROUND OF THE INVENTION

A trunk is used to receive and protect various articles to facilitate transportation. If the quantity of articles is fixed, an appropriate-size trunk or box can be adopted to package the articles. However, for a common person, carried articles usually obviously vary in his tour. Generally, the luggage of the return tour is much greater than that of the outgoing tour. Therefore, it is hard to select an appropriate-size trunk.

If a tourist prepares a bigger trunk for the return-tour luggage, the unfixed articles in the trunk will collide and break in the outgoing tour. If the tour selects a smaller trunk, the articles will be squeezed and damaged in the return tour.

Therefore, some people stuffs soft luggage bags in a trunk and uses the soft bags to receive articles in the return tour. As souvenirs get more and more along the tour, a tourist usually has to carry several bags or trunks in his return tour. The tourist is likely to lose his luggage when carrying too many pieces of luggage. Besides, a soft bag does not have a hard casing to protect articles thereinside from impacts. Further, a soft bag can be easily incised with a knife and stolen by a thief. Therefore, soft bags still have drawbacks and cannot satisfy the requirements of customers.

### SUMMARY OF THE INVENTION

The primary objective of the present invention is to provide an anti-collision air bag for protecting articles inside a trunk.

The anti-collision air bag of the present invention is placed inside a trunk to protect articles inside the trunk and comprises: an air bag and a check valve, wherein the air bag has an inflation inlet; the check valve is arranged in the inflation inlet and has a movable platelet, and the movable platelet is arranged inside the air bag and moved outward from the interior of the air bag to cover the inflation inlet.

### BRIEF DESCRIPTION OF THE DRAWINGS

FIG. 1 is a diagram schematically showing the structure of the air bag according to the present invention.

FIG. 2 is a diagram schematically showing the structure of the check valve in an airtight state according to one embodiment of the present invention.

FIG. 3 is a diagram schematically showing the structure of the check valve in an air-pumping state according to one embodiment of the present invention.

FIG. 4 is a diagram schematically showing the structure of the check valve in an airtight state according to another embodiment of the present invention.

FIG. 5 is a diagram schematically showing the structure of the check valve in an air-pumping state according to another embodiment of the present invention.

FIG. 6 is a diagram schematically showing that the air bag of the present invention applies to a trunk.

FIG. 7 is a diagram schematically showing that the air bag connects with an inflation hose according to yet another embodiment of the present invention.

FIG. 8 is a diagram schematically showing the application of the air bag according to still another embodiment of the present invention.

FIG. 9 is a first diagram schematically showing one air-release method according to further another embodiment of the present invention.

FIG. 10 is a second diagram schematically showing one air-release method according to further another embodiment of the present invention.

FIG. 11 is a diagram schematically showing one method for directly releasing air from the exterior of a trunk according to further another embodiment of the present invention.

### DETAILED DESCRIPTION OF THE PREFERRED EMBODIMENTS

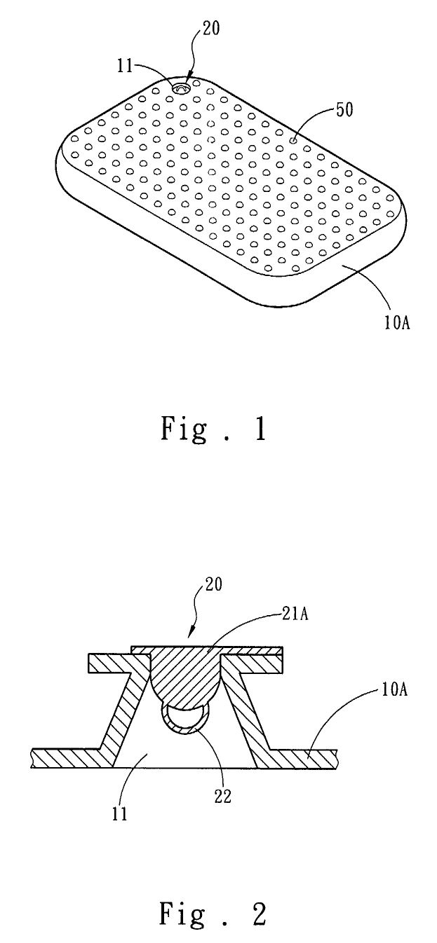

Below, the embodiments are described in detail in cooperation with the drawings to make easily understood the characteristics, objectives and accomplishments of the present invention. Refer to FIG. 1 and FIG. 2. The anti-collision air bag of the present invention comprises: an air bag 10A and a check valve 20, wherein the air bag 10A has an inflation inlet 11, and the inflation inlet 11 has a trumpet shape with the larger opening thereof arranged outside, and the check valve 20 is arranged in the inflation inlet 11.

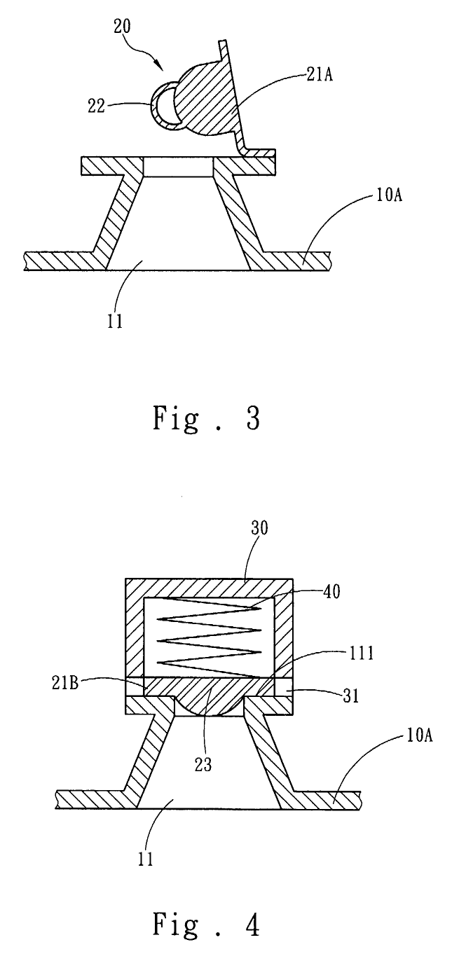

Refer to FIG. 3. The check valve 20 has a movable platelet 21A arranged inside the air bag 10A, and the movable platelet 21A moves outward from the interior of the air bag 10A to cover the inflation inlet 11. The movable platelet 21A may be installed in two ways. As shown in FIG. 3, in one embodiment of the present invention, one end of the movable platelet 21A is flexibly coupled to the inflation inlet 11. In this embodiment, the movable platelet 21A has a pull element 22, and the pull element 22 extends through the inflation inlet 11 to emerge from the air bag 10A. When inflation is intended, an inflation device (not shown in the drawing), such as an air blower or an air pump, is directly inserted into the inflation inlet 11 to push the movable platelet 21A and open the inflation inlet 11. Then, air is pumped into the air bag 21A. When inflation is completed, the inflation device is removed, and the pull element 22 is pulled out to securely close the inflation inlet 11 with the movable platelet 21A (as shown in FIG. 2). The air bag 10A is made of a non-elastic material; therefore, air will not be released from the non-elastic air bag 10A immediately after the inflation action stops.

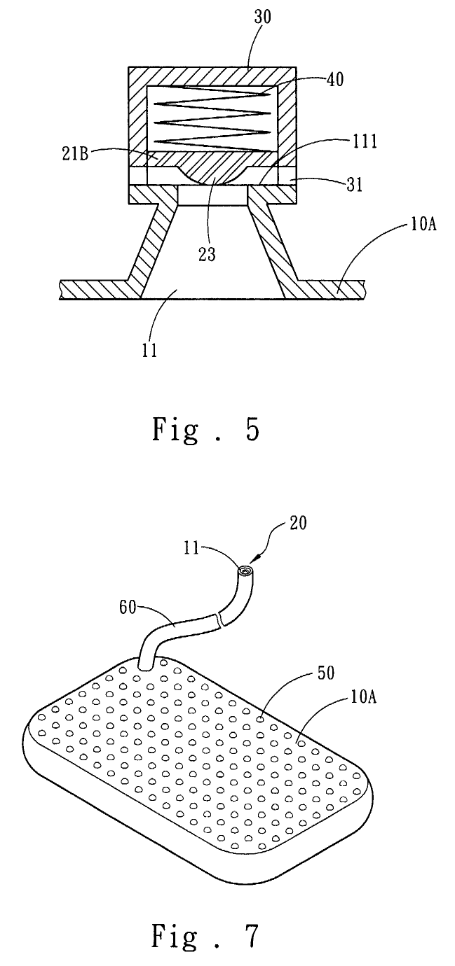

Refer to FIG. 4 and FIG. 5 for the other way of installing the movable platelet. In another embodiment, the inflation inlet 11 is capped by an accommodation seat 30 arranged in the inner side of the air bag 10A. The inflation inlet 11 has a flange 111 contacting the accommodation seat 30. The accommodation seat 30 has a plurality of openings 31 annularly arranged near the inflation inlet 11. An elastic element 40 is accommodated inside the accommodation seat 30, and the movable platelet 21B is arranged on the elastic element 40, and the elastic element 40 can elastically push the movable platelet 21B to seal the openings 31. The movable platelet 21B has a protrusion 23 extending through the inflation inlet 11 and emerging from the air bag 10A. The protrusion 23 facilitates the movable platelet 21B being pushed inward during inflation. When inflation is intended, an inflation device, such as an air pump, is directly inserted into the inflation inlet 11 to push inward the movable platelet 21B and open the inflation inlet 11. Then, air is pumped into the air bag 10A. When inflation is completed, the inflation device is removed, and the elastic element 40 pushes out the movable platelet 21B to seal the inflation inlet 11.

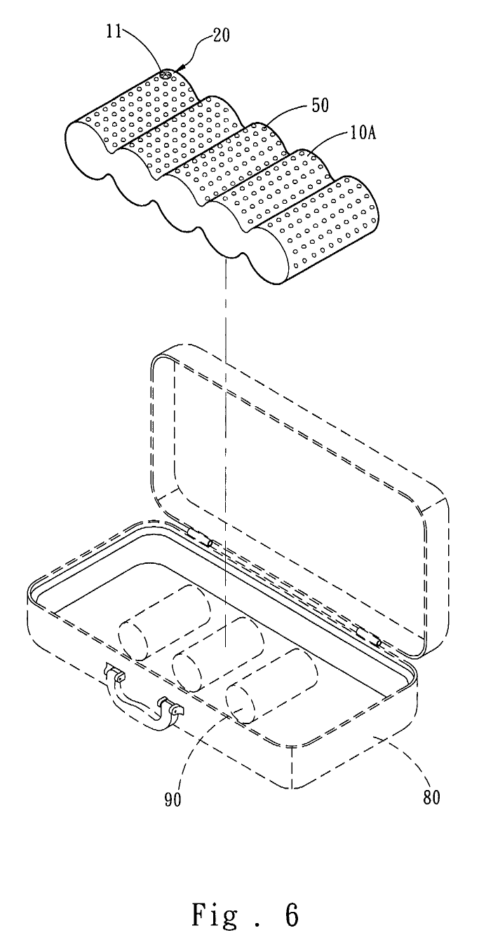

Refer to FIG. 6 for the application of the present invention. Firstly, articles 90 are placed inside a trunk 80. Next, a non-inflated air bag 10A is overlaid over the articles 90, wherein the air bag 10A may have various types. Next, the air bag 10A is inflated. After inflation is completed, air inside the air bag 10A is sealed by the check valve 20, and the air bag 10A filled with air becomes elastic. Then, the air bag 10A can fix and protect the articles 90. Besides, the surface of the air bag 10A may have a plurality of grain-like slip-proof structures 50 to enhance the protection function.

Refer to FIG. 7. In yet another embodiment of the present invention, an inflation hose 60 is coupled to the inflation inlet 11 of the air bag 10A, and the check valve 20 is arranged in the terminal of the inflation hose 60. Thus, a user can connects an inflation device to the inflation hose 60 to pump air into the air bag 10A. After inflation, the inflation hose 60 can be conveniently folded and stuffed into the trunk.

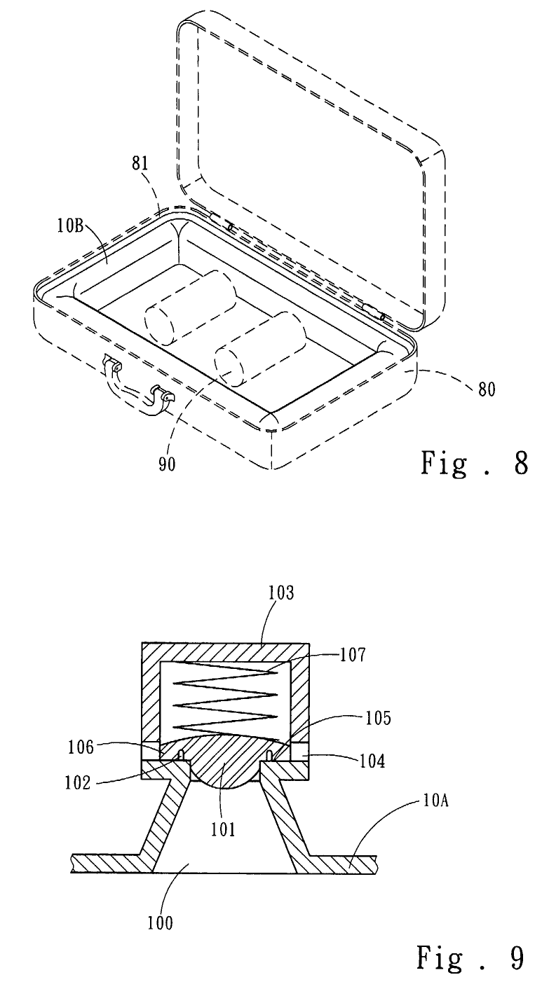

Refer to FIG. 8. In still another embodiment of the present invention, an air bag 10B of the present invention may be stuck to inner walls 81 of a trunk 80 or a paper box (such as a package paper box for industrial products). Thus, the accommodation space can be varied according to the quantity of accommodated articles 90 via varying the amount of the inflated air. Then, the articles 90 can be protected by the elasticity of the air bag 10B.

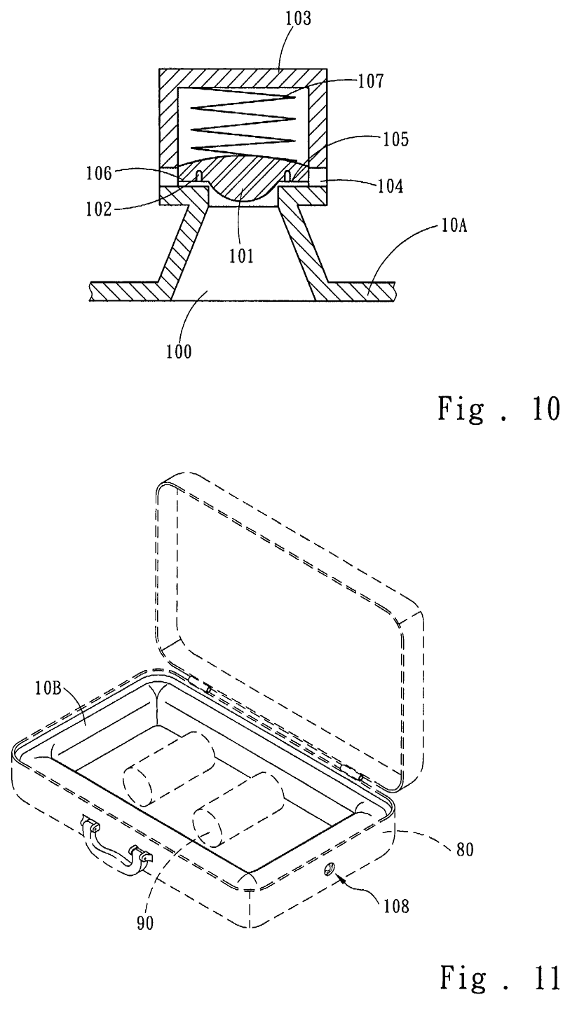

Refer to FIG. 9 and FIG. 10 for one air-release method of the present invention. In further another embodiment of the present invention, an air-release outlet 100 is arranged on the air bag 10A. The air-release outlet 100 is capped by an accommodation seat 103 arranged in the inner side of the air bag 10A. The air-release outlet 100 has a flange 105 contacting the accommodation seat 103. The accommodation seat 103 has a plurality of openings 104 annularly arranged near the air-release outlet 100. An elastic element 107 is accommodated inside the accommodation seat 103, and a movable platelet 106 arranged on the elastic element 107, and the elastic element 107 can elastically push the movable platelet 106 to seal the air-release outlet 100.

The movable platelet 106 has a protrusion 101 extending through the air-release outlet 100 and emerging from the air bag 10A. The protrusion 101 has air-release holes 102. When air release is intended, the movable platelet 106 is pushed inward to open the air-release outlet 100. Thus, the air-release holes 102 have gaps to release air inside the air bag 10A. After air release is completed, the movable platelet 106 is freed, and the elastic element 107 pushes out the movable platelet 106 to seal the air-release outlet 100.

Refer to FIG. 11 for another air-release method of the present invention. In further another embodiment of the present invention, an air-release valve 108 is arranged in the exterior of a trunk 80 or a box, and the air-release valve 108 connects with the air-release outlet 100 (not shown in the drawing) of the air bag 10B. If the air-filled air bag 10B is found to be over-inflated after the trunk 80 is closed, the excess air can be directly released via the external air-release valve 108 without opening the trunk 80.

What is claimed is:

1. An anti-collision air bag for protecting articles in a trunk, placed inside a trunk to protect articles inside said trunk and characterized in comprising
an air bag placed inside said trunk and having an inflation inlet.

2. The anti-collision air bag for protecting articles in the trunk according to claim 1, wherein said inflation inlet has a check valve, and said check valve has a movable platelet; said movable platelet is arranged inside said air bag and moves outward from the interior of said air bag to cover said inflation inlet; air can be inflated into said air bag via said inflation inlet, and said check valve can block the leakage of the air inside said air bag; thus, said air bag is full of air and has elasticity.

3. The anti-collision air bag for protecting articles in the trunk according to claim 2, wherein an inflation hose is coupled to said inflation inlet, and said check valve is arranged in the terminal of said inflation hose.

4. The anti-collision air bag for protecting articles in the trunk according to claim 1, wherein the surface of said air bag has a plurality of grain-like slip-proof structures to enhance the protection function.

5. The anti-collision air bag for protecting articles in the trunk according to claim 1, wherein said air bag is stuck to inner walls of said trunk.

6. The anti-collision air bag for protecting articles in the trunk according to claim 1, wherein said check valve has a movable platelet, and said movable platelet has a pull element, and said pull element extends through said inflation inlet to emerge from said air bag.

7. The anti-collision air bag for protecting articles in the trunk according to claim 1, wherein said inflation inlet has a trumpet shape with the larger opening thereof arranged outside.

8. The anti-collision air bag for protecting articles in the trunk according to claim 1, wherein said air bag has an air-release outlet, and said air-release outlet is capped by an accommodation seat arranged in the inner side of said air bag;
said air-release outlet has a flange contacting said accommodation seat; said accommodation seat has a plurality of openings annularly arranged near said air-release outlet; an elastic element is accommodated inside said accommodation seat, and a movable platelet arranged on said elastic element; said elastic element can elastically push said movable platelet to seal said air-release outlet; said movable platelet has a protrusion extending through said air-release outlet and emerging from said air bag, and said protrusion has air-release holes.
